(19) United States
(12) Patent Application Publication
(10) Pub. No.: US 2010/0119714 A1
(43) Pub. Date: May 13, 2010

(54) METHOD AND DEVICE FOR PRODUCING AN AT LEAST ESSENTIALLY WOOD-FREE COATED PAPER WEB

(76) Inventor: John Bergman, Ulm (DE)

Correspondence Address: TAYLOR & AUST, P.C., P.O. Box 560, 142. S Main Street, Avilla, IN, 46710, US

(21) Appl. No.: 12/645,059

(22) Filed: Dec. 22, 2009

Related U.S. Application Data
(63) Continuation of application No. PCT/EP2008/057335, filed on Jun. 12, 2008.

(30) Foreign Application Priority Data
Jun. 22, 2007 (DE) 10 2007 029 328.5

(51) Int. Cl. B05D 3/02; B05D 1/30; B05D 1/02; B05D 1/36; B05C 5/00; B05C 9/10; B05D 3/12

(52) U.S. Cl. 427/314; 427/420; 427/421.1; 427/402; 118/300; 118/58

(57) ABSTRACT

The present invention provides a method and device for the efficient production of a substantially wood free coated web. In particular, a method for producing an at least substantially wood free coated web includes the application of a double coating on at least one side of the web, whereby the last coating application occurs by means of a contactless coating process.

### CROSS REFERENCE TO RELATED APPLICATIONS

This is a continuation of PCT application No. PCT/EP2008/057335, entitled “METHOD AND DEVICE FOR PRODUCING AN AT LEAST ESSENTIALLY WOOD-FREE COATED PAPER WEB”, filed Jun. 12, 2008, which is incorporated herein by reference.

### BACKGROUND OF THE INVENTION

1. Field of the Invention

The present invention relates to a method and a device for producing a substantially wood free, coated web.

2. Description of the Related Art

With hitherto known methods of producing a wood free or almost wood free double coated paper web at higher speeds of more than 1400 m/min, the following segments are provided: gap former; press section; pre-drying section pre-calender with softnip, hard nip or wide nip extended in direction of web travel; metered size press (MSP) for the application of glue or for the purpose of pre-coating; blade coater; blade coater; and an online or offline multi-nip calender for degrees of gloss.

The fundamental disadvantage of the hitherto known concepts consists in that the overall efficiency (e.g. time and material) is considerably reduced by the blade coaters. In a conventional method with an offline calendar, the loss of time in the area of the two blade coaters is approximately 4 to approximately 7%. Due to this substantial loss of time, the maximum speed potential of the paper machine cannot be completely utilized.

Currently, the furnish for the wood free or approximately wood free double coated quality levels includes the following: needle bleached Kraft pulp, long fiber (NBKP); leaf bleached Kraft pulp, short fiber (LBKP); bleached chemo-thermo mechanical pulp, short fiber (BCTMP SF); and filler, whereby the fiber content of the furnish consists of at least 85% pulp fibers NBKP and LBKP.

In a method to produce a wood free coated mat or semi-mat web which is known from WO 2005/071158 A1, the web is coated after pre-calendering on at least one side by means of a device for the application of a liquid or highly viscous coating medium and is subsequently dried by means of at least one drying device. Prior to pre-calendering, the web is single coated on a first side by means of a film or curtain coater.

What is needed in the art is an improved method and device for the production of a substantially wood free coated web with which the time efficiency potential for double coating on at least one web side is substantially improved within the paper manufacturing process.

### SUMMARY OF THE INVENTION

The present invention provides a method and device for the efficient production of a substantially wood free coated web. In particular, the method of the present invention for producing an at least substantially wood free coated web includes the application of a double coating on at least one side of the web, whereby the last coating application occurs by means of a contactless coating process.

One important aspect of the present invention is the avoidance of direct application coating systems which operate with stationary doctor blade elements, for example so-called blade coaters. The stress upon the web resulting from the relative speed between doctor blade and web increases the number of web breaks. Therefore, at least the last coating device operates contactless according to the present invention.

The last coating application is, for example, applied by means of a curtain coater and/or by means of a spray coater.

According to one embodiment of the present invention,n the fibrous component of the furnish may consist of less than 85% pulp fibers NBKP and LBKP, for example, of less than 75%, or less than 60% pulp fibers. The remainder may consist of wood containing fibers (e.g. mechanical wood pulp and/or BCTMP-SF). A paper web which is produced from this furnish and which contains a component of pulp fibers of more than 55% is referred to below as a “substantially wood-free paper web”. Compared with the current state of the art the furnish of expensive fibrous material can be reduced at the same or better coating quality, with the inventive solution.

Here, the fiber content in the web is essentially consistent with that in the furnish, whereby differences in the fiber content between furnish and paper web can occur due to retention.

A second embodiment of the method of the present invention is characterized in that the pre-coating is applied by means of a film coater and/or by means of a contactless coating process. The coating medium is applied by means of a surface which moves together with the web, as is the case, for example, with a film coater. This reduces the stress on the web compared to the blade coating process. If, following a pre-drying of the web, a color coat is applied as a pre-coating application, then the web may be run through a pre-calender unit prior to the application of the color pre-coat. If, however, in contrast, a glue is applied as a pre-coat following a pre-drying of the web, then the web may be run through a calender following the glue application. A higher consistency of the applied glue has an effect on the coating quality of the last, contactless coating application. According to a further embodiment of the present invention, the consistency can be approximately >12%, for example, >15% or 20%.

The web may be carried through the press section in a closed loop. In this instance therefore, a closed web routing is provided in the press section whereby the web is supported, for example, by a clothing and/or a felt which is provided in the press, a transfer belt, etc. The web may be carried in the press section through only one shoe press with only one wide nip.

According to a third embodiment, the web can also be routed in the press section through several shoe presses arranged in tandem, each being equipped with a wide nip.

The web may also be routed through at least one calender. For this purpose the web can, for example, be carried through at least one calender with a soft nip which is formed between two calender rolls, at least one of which is equipped with a soft synthetic material cover, especially compared to steel rolls or a chilled roll.

Alternatively, or in addition, the web can also be routed through at least one calender with a hard nip which is formed between two calender rolls, for example, steel rolls and/or chilled rolls, each of which possess a hard roll surface, especially compared to a synthetic material cover.

Alternatively, or in addition, the web can also be routed through at least one calender, especially a shoe calender or a metal belt calender with a wide nip that is extended in the direction of web travel.

The device of the present invention is accordingly characterized in that devices are provided to apply a double coating onto at least one side of the web, whereby a contactless coating device is provided for the application of the final coating application.

A curtain coater may, for example, be utilized. By using the curtain coating process, the time efficiency compared to the conventional doctor blade coating methods can be improved by approximately 3 to approximately 6%. Here it is assumed that the web breaks occurring in the after-drying sections occur at the same frequency as with the blade coaters. The additional advantage in connection with the curtain coating process exists in that already at low coating weights a substantially greater coating coverage can be achieved. This results in a significant improvement of the potential to relocate ash from the coating layer to the filler, thus bringing about considerable cost savings for the paper manufacturer. The paper quality can be optimized by appropriate pre-calendering of the paper prior to coating by means of the curtain coater or coaters.

The optimum quality range for the concept which is operated entirely online is the range of approximately 60 to approximately 200 g/m², for example, in the range of approximately 80 to approximately 150 g/m².

The final calendering of the paper can be implemented online or, if necessary, also offline. The fundamental advantage of the curtain coating process compared to a conventional blade coating process consists in that the efficiency of calendering is substantially higher while the danger of deposits on the calender rolls is reduced.

The inventive process as well as the inventive device can be utilized for the production of an at least essentially wood free coated paper web with a filler content of > approximately 8%, for example, > approximately 10% or approximately 12% at a basis weight of ≦ approximately 90 g/m² and/or with a filler content of > approximately 12%, for example, approximately 14% at a basis weight of ≧90 g/m² and/or with a coating weight of the outer coating layer of ≦ approximately 10, for example, ≦ approximately 9 and ≦ approximately 8 g/(m² per side) at a basis weight of < approximately 90 g/m² and/or with a coating weight of the outer coating layer of ≦ approximately 16, for example, ≦ approximately 14 and ≦ approximately 12 g(/m² per side) at a basis weight of approximately 90 g/m².

### BRIEF DESCRIPTION OF THE DRAWINGS

The above-mentioned and other features and advantages of this invention, and the manner of attaining them, will become more apparent and the invention will be better understood by reference to the following description of embodiments of the present invention taken in conjunction with the accompanying drawings, wherein:

FIG. 1 is a schematic illustration of an exemplary design variation of a device for the production of an at least essentially wood free coated paper web;

FIGS. 2a and 2b illustrate a simplified schematic partial depiction of an additional exemplary design variation of the device including a high efficiency drier;

FIG. 3 is a schematic depiction of an arrangement which includes two curtain coaters for the application of coating color onto both sides of the web in a contactless process; and

FIG. 4 is a diagram wherein the coverage characteristics of a curtain coater are compared with the coverage characteristics of a blade coater.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

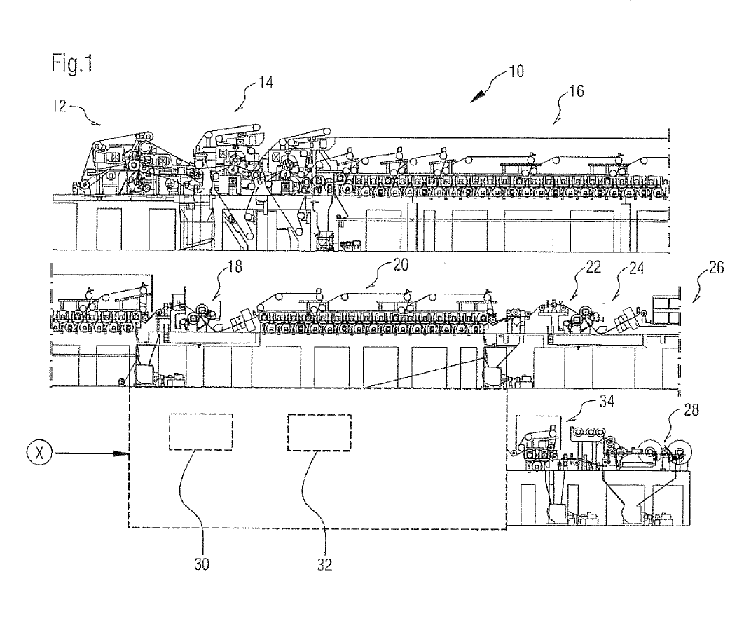

Referring now to the drawings, and more particularly to FIG. 1, there is shown a schematic depiction of an exemplary embodiment of device 10 for the production of an at least substantially wood free coated paper web including wire section 12, press section 14 of pre-drying section 16, device 18 for the application of glue, after-drying section 20, calender or pre-calender 22, device 24 for the application of a color coating, drying device 26 and reel winder 28.

As can be seen from FIG. 1, device 18 for the application of glue and device 24 for the application of color respectively can, for example, be a film coater.

In area “X” after drying device 26 and before reel winder 28, contactless coating devices 30, 32 are provided as the last applicator device for a two-sided coating application. Final applicator devices 30, 32 can specifically be in the embodiment of curtain coaters.

The optimum quality range for the concept which is operated entirely online is the range of approximately 60 to approximately 200 g/min², for example, in the range of approximately 80 to approximately 150 g/m².

The final calendering of the paper can be implemented online or, if necessary, offline. The advantages of the curtain coating process compared to a conventional blade coating process is that the efficiency of calendering is substantially higher while the risk of deposits on the calender rolls is reduced.

The device can, therefore, include devices for applying at least one double layer of coating onto at least one web side, whereby contactless applicator device 32 is provided for the final coating application. A curtain coater and/or a spray coater is to be provided to apply the final coating application. To apply the pre-coating a film coater and/or a contactless applicator device is provided.

Following a device for pre-drying the paper web which, for example, may include pre-drying section 16 and after-drying section 20, device 24 for the application of the color pre-coating can be provided, whereby pre-calender 22 is provided prior to device 24.

Device 18 for the application of the glue is located between pre-drying section 16 and after-drying section 20. Calender 22 is provided following pre-drying section 20. The paper web is may be carried through press section 14 in a closed loop. The paper web can be carried in the press section through only one shoe press with only one shoe press nip or also through several shoe presses with one shoe press nip each which are located in tandem.

Apparatus 10 also includes, for example, at least one calender 34, which in the existing example is located, for example, between device 24 for the application of the color coating or drying device 26 and reel winder 28.

For example, at least one calender can be equipped with a soft nip which is formed between two calender rolls, at least one of which is equipped with a soft synthetic material cover, for example, compared to steel rolls or chilled rolls.

Alternatively or in addition, at least one calender can be equipped with a hard nip which is formed between two calender rolls, for example, steel rolls, each of which possess a hard roll surface.

Alternatively, or in addition at least one calender, for example, a shoe calender or a metal belt calender with a wide nip that extends in the direction of web travel can be provided. Wire section 12 includes for example, a gap former.

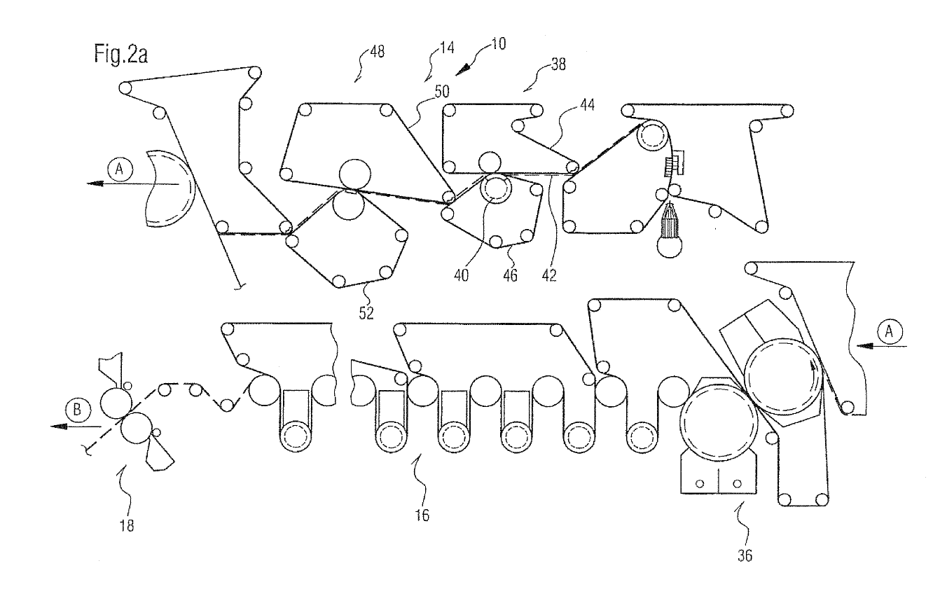

As can be seen in FIG. 2, at least one high efficiency dryer 36 can be provided after press section 14. Here, such high efficiency dryer 36 may, for example, include at least one impingement dryer (compare FIG. 2) or, for example, at least one drying cylinder whose surface temperature is > approximately 120° C. and approximately 130° C.

After high efficiency dryer 36 the paper web possess a dry content of preferably > approximately 63%.

As can also be seen in FIG. 2, a single row pre-drying section can, for example, be provided after high efficiency dryer 36. FIGS. 2a and 2b show a simplified schematic partial view of such an exemplary design form of apparatus 10 with high efficiency dryer 36 and single row pre-drying section 16 following. Wire section 12 can include a gap former.

Press section 14 includes press 38 with suction roll 40 and a nip through which paper web 42 is guided together with top felt 44 and bottom felt 46. Press 38 is followed by shoe press 48, through whose wide nip paper web 42 is guided together with top felt 50 and lower belt 52 which can, for example, be a felt or a transfer belt. After shoe press 48, high efficiency dryer 36 is provided which—in this example—includes an impingement dryer. As previously mentioned a drying cylinder can be provided alternatively or in addition, whose surface temperature is > approximately 120° C. and > approximately 130° C.

High efficiency dryer 36 is followed, for example, by single row pre-drying section 16. Following pre-drying section 16 is device 18 for the application of glue, which in this instance may comprise a film coater.

As can be seen from FIG. 2b, following device 18 for the application of glue, drying device 54, calender or pre-calender 22, film coater 56, dryer 58, curtain coater 60 for the underside of the web, curtain coater 62 for the top side of the web, contactless turning device 64 such as, for example, an Airturn, impingement dryer 66, optional calender 68, cylinder group 70, such as, for example, a draw and/or cooling group and reel winder 28 are provided in tandem, viewed in direction of web travel L. Prior to two curtain coaters 60, 62 in direction of web travel L, air boundary layer suction device 72 or respectively 74 can be provided in each case in order to produce a good coating quality.

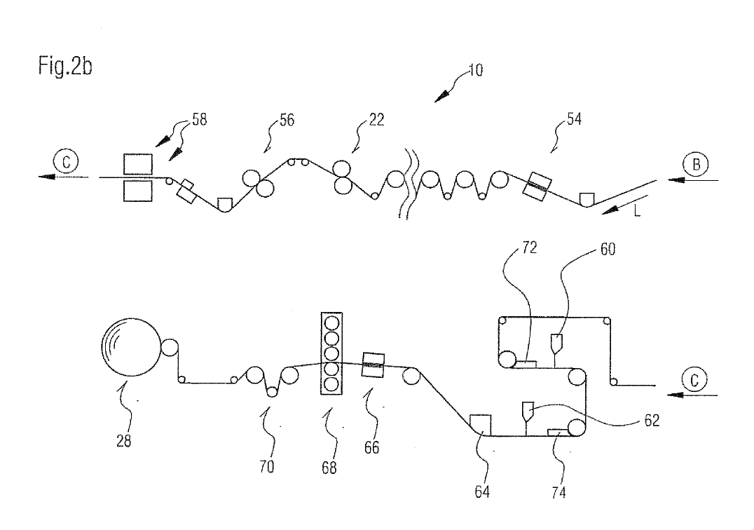

FIG. 3 is a schematic illustration of an exemplary design form of an arrangement including curtain coaters 30, 32 for the application of coating color on both web sides in a contactless process. As can be seen in FIG. 3, drying device 76 is provided following this arrangement. The arrangement according to FIG. 3 can be provided, for example, in area “X” of device 10 according to FIG. 1. Here, drying device 76 may again be provided following curtain coaters 30, 32. The inventive solution results in advantages at higher speeds, since the entire process is subject to fewer web breaks and therefore offers better runability. The following measures are contributory in this:
Former: Gap former (twin wire former);
Shoe press: Tension free—in other words, the web is continuously supported, and accordingly there are no web breaks. The shoe press provides a gentle pressing which is advantageous regarding the bulk and sufficient dewatering at higher speeds;
Pre-drying: The press is followed by a high efficiency dryer (for example impingement dryer, drying cylinder with high surface temperature > approximately 120° C. and > approximately 130° C.), after the high efficiency dryer the web has a dry content of > approximately 63%, resulting in a greater web strength in the first free draw. This is followed by a single row drying section.
Coating process: Fewer web breaks occur without doctor blades. In addition, better coverage results with a curtain coater and/or a spray coater, thereby reducing the coating weight while being able to increase the filler in the paper and rendering the process more cost effective and economical.

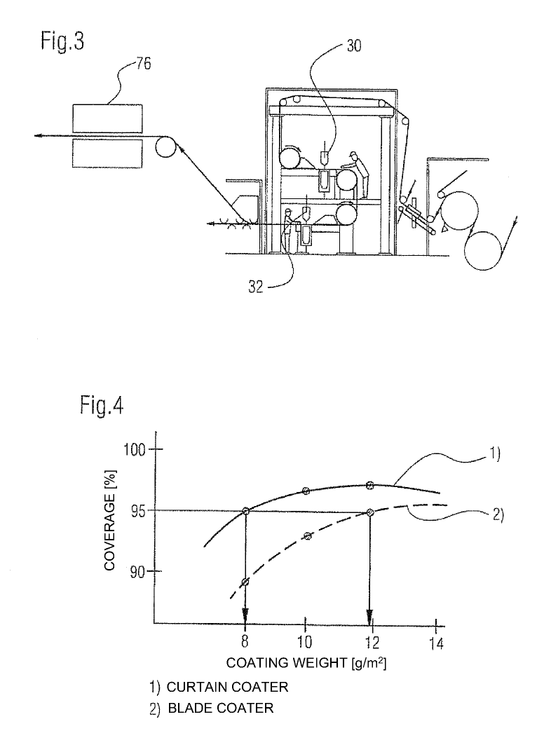

FIG. 4 is diagram in which the coverage properties of a curtain coater are compared to the coverage properties of a blade coater. The diagram shows the coverage [%] relative to the coating weight [g/m²] for a blade coater and a curtain coater. The coverage can be determined, for example, as a surface share of the coating application for which the thickness of the coating application exceeds a certain minimum thickness of, for example, 1 micrometer.

Due to the better coverage properties the coating weight with a curtain coater compared to a blade coater can be reduced at 95% coverage from approximately 12 g/m² per side to approximately 8 g/m² per side. Here, 2 times 4 g/m² more filler can be added in the pulp for bulk compensation, thereby clearly reducing the costs.

The inventive process as well as the inventive device can be utilized advantageously for the production of an at least essentially wood free coated paper web with a filler content of > approximately 8%, for example, > approximately 10% and approximately 12% at a basis weight of ≦ approximately 90 g/m² and/or with a filler content of > approximately 12%, for example, approximately 14% at a basis weight of ≧ approximately 90 g/m² and/or with a coating weight of the outer coating layer of ≦ approximately 10, for example, ≦ approximately 9 and ≦ approximately 8 g/(m² per side) at a basis weight of < approximately 90 g/m² and/or with a coating weight of the outer coating layer of ≦ approximately 16, for example, ≦ approximately 14 and ≦ approximately 12 g/(m² per side) at a basis weight of approximately 90 g/m².

The present invention hereby relates to the production process of at least essentially wood free coated papers, especially to the sequences of color coating process, glue coating process and calenders, as well as to filler contents in the paper, and coating weights.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

10 Device

12 Wire section

14 Press section

16 Pre-drying section

18 Device for the application of a glue coating

20 After-drying section

22 Calender, pre-calender

24 Device for the application of an color coating

26 Drying device

28 Reel winder

30 Contactless coater

32 Contactless coater

34 Calender

36 High efficiency dryer

38 Press

40 Suction roller

42 Paper web

44 Top felt

46 Bottom felt

48 Shoe press

50 Top felt

52 Bottom belt

54 Drying device

56 Film coater

58 Drying device

60 Curtain coater

62 Curtain coater

64 Contactless turning device, Airturn

66 Impingement drying device

68 Calender

70 Cylinder group

72 Air boundary layer suction

74 Air boundary layer suction

76 Drying device

L Direction of web travel

X Area

What is claimed is:

1. A method for producing a substantially wood free coated web, the method comprising:
applying a double coating on at least one side of the web, wherein a last coating of said double coating is applied using a contactless process.

2. The method according to claim 1, wherein said last coating is applied by at least one of a curtain coater and a spray coater.

3. The method according to claim 2, further comprising the step of applying a pre-coating using at least one of a film coater and said contactless process.

4. The method according to claim 3, further comprising the steps of pre-drying the web, applying a pre-coat after said pre-drying and running the web through a pre-calendar unit prior to said pre-coat application, wherein said pre-coat is a color coat.

5. The method according to claim 3, further comprising the steps of pre-drying the web, applying a pre-coat after said pre-drying and running the web through a calendar unit after said pre-coat application, wherein said pre-coat is a glue.

6. The method according to claim 1, further comprising the step of carrying the web through a press section in a closed loop.

7. The method according to claim 6, wherein the web is carried in said press section through only one shoe press with only one nip.

8. The method according to claim 6, wherein the web is carried in said press section through a plurality of shoe presses arranged in tandem, each of said plurality of shoe presses equipped with a wide nip.

9. The method according to claim 1, further comprising the step of carrying the web through at least one calendar.

10. The method according to claim 9, wherein said at least one calendar is two calendar rolls having a soft nip formed therebetween, at least one of said two calendar rolls having a substantially soft synthetic material cover.

11. The method according to claim 9, wherein said at least one calendar is two calendar rolls having a hard nip formed therebetween, each of said two calendar rolls including a substantially hard roll surface.

12. The method according to claim 11, wherein said two calendar rolls are steel rolls.

13. The method according to claim 11, wherein said at least one calendar is one of a shoe calendar and a metal belt having a wide nip extending in a direction of web travel.

14. The method according to claim 13, further comprising the step of producing the substantially wood free coated paper web having at least one of a filler content of >8% at a basis weight of ≦90 g/m² and a filler content of >12% at a basis weight of ≧90 g/m² and a coating weight of an outer coating layer of said double coating ≦10 g/m² per side of the web at a basis weight of <90 g/m² and a coating weight of said outer coating layer of ≦16 at a basis weight of approximately 90 g/m².

15. The method according to claim 14, wherein said filler content at a basis weight of ≦90 g/m²is >10%.

16. The method according to claim 15, wherein said filler content at a basis weight of ≦90 g/m²is >12%.

17. The method according to claim 14, wherein said filler content at a basis weight of ≧90 g/m² is 14%.

18. The method according to claim 14, wherein said coating weight of said outer coating layer at said basis weight <90 g/m² is ≦9 g/m².

19. The method according to claim 18, wherein said coating weight of said outer coating layer at said basis weight <90 g/m² is ≦8 g/m².

20. The method according to claim 14, wherein said coating weight of said outer coat layer at a basis weight of 90 g/m² is ≦14 g/m² per side of the web.

21. The method according to claim 20, wherein said coating weight of said outer coat layer at a basis weight of 90 g/m² is ≦12 g/m² per side of the web.

22. The method according to claim 14, wherein a fibrous content of one of a furnish and a web is less than 85% pulp fibers.

22. The method according to claim 22, wherein said fibrous content of one of said furnish and the web is less than 75% pulp fibers.

23. The method according to claim 22, wherein said fibrous content of one of said furnish and the web is less than 60% pulp fibers.

24. An apparatus for producing an at least substantially wood-free coated web, the apparatus comprising:
a plurality of coating application devices configured to apply a double coating onto at least one side of the web, wherein at least one of said plurality of coating application devices is a contactless coating device configured for applying a last coating of said double coating on the web.

25. The apparatus according to claim 24, wherein said contactless coating device is at least one of a curtain coater and a spray coater.

26. The apparatus according to claim 25, further comprising at least one of a film coater and a pre-coat contactless coater application device.

27. The apparatus according to claim 26, wherein said pre-coat contactless coater application device is configured to apply a color pre-coat, said pre-coat contactless coater application device positioned after a web pre-drying device and before a pre-calender.

28. The apparatus according to claim 26, wherein said film coater is a glue applicator device positioned after a web pre-drying device and before a calender

29. The apparatus according to claim 28, further comprising a press section, wherein the apparatus is configured for the web to be carried through said press section in a closed loop.

30. The apparatus according to claim 29, wherein said press section includes one shoe press and one nip, the apparatus configured to carry the web in said press section through said one shoe press and said one nip.

31. The apparatus according to claim 29, wherein said press section includes a plurality of shoe presses arranged in tandem, each of said plurality of said shoe presses equipped with one wide nip.

32. The apparatus according to claim 1, further comprising at least one calender.

33. The apparatus according to claim 32, wherein said at least one calendar is two calendar rolls having a soft nip therebetween, at least one of said two calender rolls including a soft synthetic material cover.

34. The apparatus according to claim 32, wherein said at least one calendar is two calendar rolls having a hard nip therebetween, each of said two calender rolls being hard rolls.

35. The apparatus according to claim 34, wherein said two calender rolls are steel rolls.

36. The apparatus according to claim 35, wherein said at least one calender is one of a shoe calender and a metal belt calender having a wide nip extending in a direction web travel.

37. The apparatus according to claim 35, further comprising a gap former.

38. The apparatus according to claim 37, further comprising a high efficiency drier after said press section.

39. The apparatus according to claim 38, further comprising at least one impingement drier after said press section.

40. The apparatus according to claim 39, further including at least one drying cylinder after said press section, said at least one drying cylinder configured to have a surface temperature greater than approximately 120° C.

41. The apparatus according to claim 40, wherein said surface temperature is approximately 130° C.

42. The apparatus according to claim 41, wherein after said high efficiency dryer, the web has a dry content of greater than approximately 63%.

43. The apparatus according to claim 42, further comprising a single row pre-drying section after said high efficiency dryer.
